(19) United States
(12) Patent Application Publication
(10) Pub. No.: US 2013/0205519 A1
(43) Pub. Date: Aug. 15, 2013

(54) ACCESSORY FOR A RECIPROCATING SAW

(71) Applicant: Milwaukee Electric Tool Corporation, (US)

(72) Inventors: Michael S. Steele, Waukesha, WI (US); Sean T. Kehoe, Waukesha, WI (US)

(73) Assignee: Milwaukee Electric Tool Corporation, Brookfield, WI (US)

(21) Appl. No.: 13/762,846

(22) Filed: Feb. 8, 2013

Related U.S. Application Data
(60) Provisional application No. 61/597,521, filed on Feb. 10, 2012.
(60) Provisional application No. 61/684,579, filed on Aug. 17, 2012.

(51) Int. Cl. B25F 3/00; A46B 13/02; B25F 5/00

(52) U.S. Cl. CPC B25F 3/00; B25F 5/00; A46B 13/02
USPC 15/21.1; 279/143; 15/146; 173/46

(57) ABSTRACT

An accessory for a reciprocating power tool, the accessory including an attachment portion, a body portion, an accessory block, and an accessory element. The attachment portion is configured to be coupled to the reciprocating power tool. The body portion extends from the attachment portion and includes a mating member. The accessory block includes an accessory mating portion configured to mate with the mating member of the body portion. The accessory mating portion includes a locating member that projects towards the mating member. The locating member is received within the mating member for mating with the mating member. The accessory element is coupled to the accessory block for engaging a workpiece.

### CROSS-REFERENCE TO RELATED APPLICATIONS

The present application claims priority to U.S. Provisional Patent Application Ser. No. 61/597,521, filed Feb. 10, 2012, entitled ACCESSORY FOR A RECIPROCATING SAW, and to U.S. Provisional Patent Application Ser. No. 61/684,579, filed Aug. 17, 2012, entitled ACCESSORY FOR A RECIPROCATING SAW, the entire contents of all of which are hereby incorporated by reference.

### BACKGROUND

The present invention relates to accessories for power tools, and more particularly to an accessory for a reciprocating tool.

Reciprocating tools, such as reciprocating saws, typically include removable blades to allow for replacement of worn or damaged blades.

### SUMMARY

In one embodiment, the invention provides an accessory for a reciprocating power tool. The accessory includes an attachment portion configured to be coupled to the reciprocating power tool and a body portion extending from the attachment portion. The body portion includes a mating member. The accessory also includes an accessory block having an accessory mating portion configured to mate with the mating member of the body portion. The accessory mating portion includes a locating member that projects towards the mating member, the locating member being received within the mating member for mating with the mating member. The accessory also includes an accessory element coupled to the accessory block, the accessory element for engaging a workpiece.

In another embodiment the invention provides an accessory block for a reciprocating power tool having an adapter. The accessory block includes an accessory element configured to engage a workpiece to perform an operation on the workpiece. The accessory block also includes an accessory mating portion configured to mate with the adapter. The accessory mating portion includes a receptacle configured to receive the adapter and a locating member having a shape that corresponds with a shape of the adapter for mating with the adapter. The locating member is disposed in the receptacle.

In another embodiment, the invention provides a reciprocating power tool. The reciprocating power tool includes a motor having a drive shaft, a blade clamp mechanism, a drive mechanism coupled to the motor for converting rotational motion of the drive shaft into reciprocating motion of the blade clamp mechanism, an accessory, an accessory block and an accessory element. The accessory has an attachment portion configured to be coupled to the blade clamp mechanism and a body portion extending from the attachment portion and including a mating member. The accessory block has an accessory mating portion configured to mate with the mating member. The accessory mating portion includes a receptacle configured to receive the mating member and a locating member having a shape that corresponds with the mating member for mating with the mating member. The locating member is disposed in the receptacle. The accessory element is coupled to the accessory block and is for engaging a workpiece.

Other aspects of the invention will become apparent by consideration of the detailed description and accompanying drawings.

### BRIEF DESCRIPTION OF THE DRAWINGS

FIG. 1 is a side view of a reciprocating power tool for receiving an accessory according to an embodiment of the invention, the reciprocating power tool shown receiving a saw blade.

FIG. 2 is a cross-section of the reciprocating power tool shown in FIG. 1, and including a shoe.

FIG. 3 is a perspective view of an accessory base for a reciprocating saw according to one embodiment of the invention.

FIG. 4 is a side view of the accessory base shown in FIG. 3.

FIG. 5 is an exploded view of the accessory base shown in FIG. 3.

FIG. 6 is a perspective view of an accessory base for a reciprocating saw according to another embodiment of the invention.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. detailed description

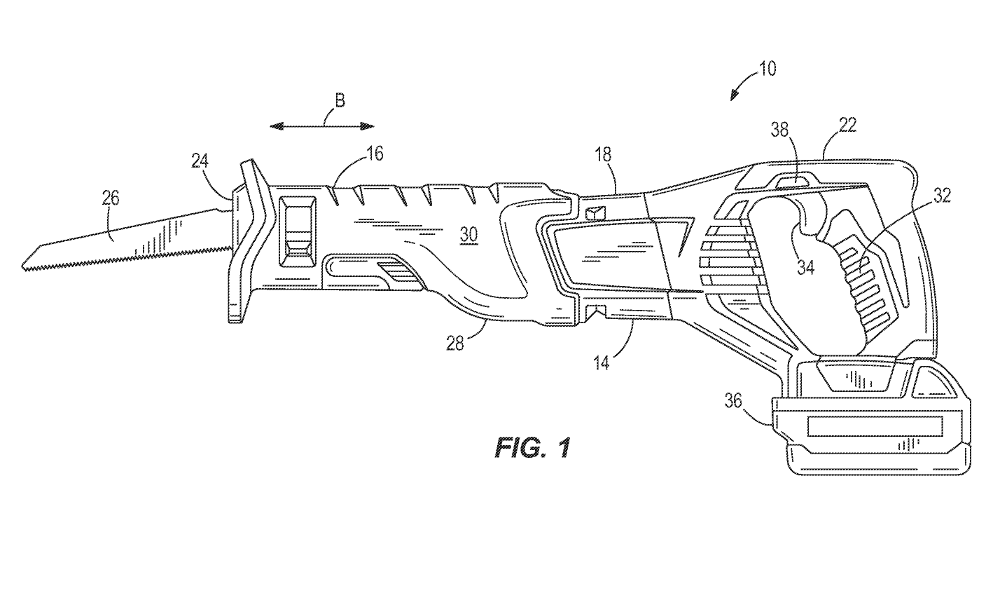

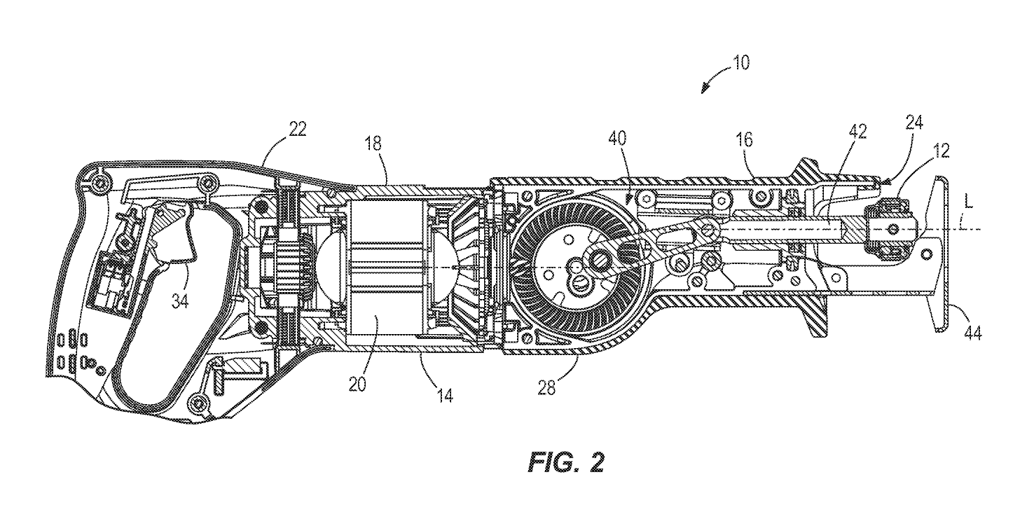

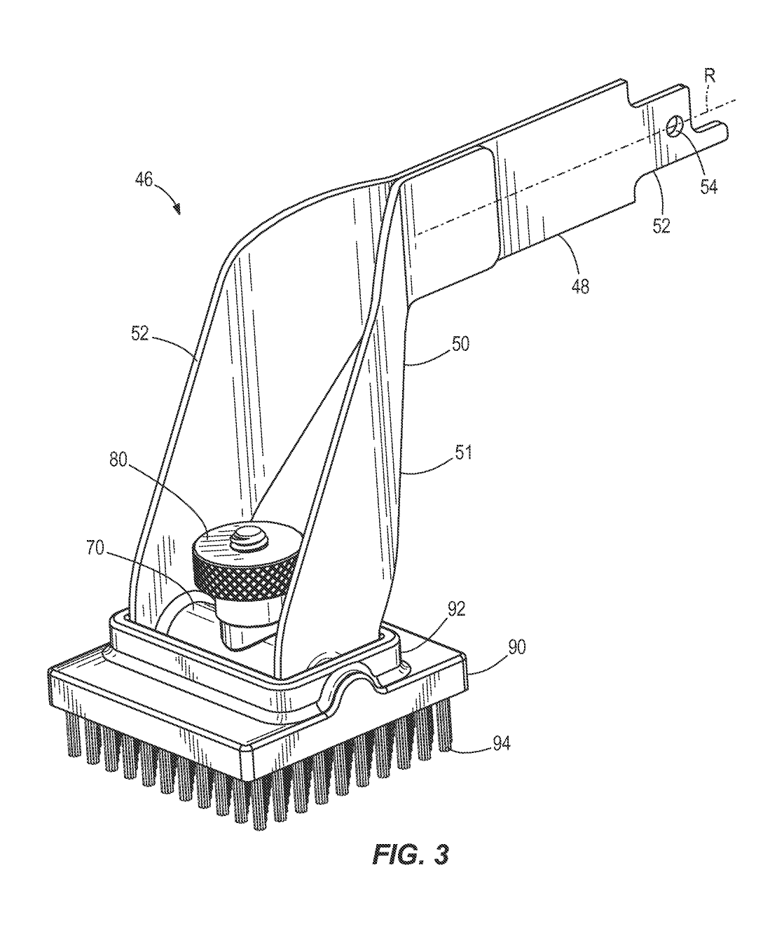

FIGS. 1 and 2 illustrate a reciprocating power tool 10 including a blade clamp mechanism 12. The illustrated reciprocating power tool 10 is a reciprocating saw; however, in other embodiments, other reciprocating power tools may be employed. As shown in FIGS. 1 and 2, the power tool 10 includes a saw housing 14 having a forward portion 16, a body portion 18 housing a motor 20 (FIG. 2), and a handle portion 22. The forward portion 16 of the saw housing 14 includes a blade receiving aperture or end 24 that receives a saw blade 26 (FIG. 1) or an accessory 46 (FIG. 3-6) according to one embodiment of the invention, as will be described in greater detail below. The saw blade 26, or accessory 46, is releasably coupled to a blade clamp mechanism 12 (FIG. 2) positioned within the saw housing 14, specifically, within the receiving aperture 24. In the illustrated embodiment, a boot or grip portion 28 is positioned over the forward portion 16 of the saw housing 14. In this embodiment, the boot 28 provides a grip area 30 for the user and/or provides protection to the tool 10. In some embodiments, the boot 28 is over-molded onto the forward portion 16. The handle portion 22 includes an over-mold to define an ergonomic grip 32 and allows a user to hold and control the power tool 10.

With continued reference to FIGS. 1 and 2, the power tool 10 includes a trigger-type power switch 34 for activating a power supply 36 of the tool 10 and a button or switch 38 for selecting a speed level (e.g., a high speed or a low speed) for reciprocating the saw blade 26. In the illustrated embodiment, the power supply 36 is a rechargeable battery pack. The battery pack 36 is releasably coupled to the handle portion 22 to provide power to the power tool 10, and is releasable away from and rearward of the handle portion 22. In the illustrated embodiment, the battery pack 36 is an eighteen-volt (18V) rechargeable power tool battery pack. In other embodiments, the battery pack 36 may be a twelve-volt (12V), a twenty-four-volt (24V), or other various voltages. According to another embodiment, the power supply 36 may be an alternating current (AC) power provided via a corded plug electrically coupled to a wall outlet or any number of suitable powering options.

With reference to the cross section illustrated in FIG. 2, the reciprocating tool 10 also includes a drive mechanism 40 positioned substantially within the housing 14. The drive mechanism 40 is coupled to the motor 20 and to a spindle 42 for transferring rotational motion of a shaft of the motor 20 into reciprocating motion of the spindle 42 along a longitudinal axis L relative to the housing 14. The blade clamp mechanism 12 is disposed at a distal end of the spindle 42 for receiving the accessory 46. The blade clamp mechanism 12 secures the accessory 46 to the spindle 42 for reciprocation with the spindle 42 in a direction B (FIG. 1) parallel to the longitudinal axis L. In other embodiments, other suitable types and configurations of blade clamp mechanisms may be employed.

The reciprocating tool 10 also includes a removable shoe 44, illustrated in FIG. 2, configured to engage a work piece and provide stability to the tool 10 while in operation. The removable shoe 44 may be removed when the accessory 46 is attached to the blade clamp mechanism 12. The shoe 44 acts as a stop to limit the depth of the saw blade 26 into the workpiece and to prevent the workpiece from engaging the saw blade 26 at a connection of the saw blade 26 to the tool 10, e.g., at the blade clamp mechanism 12. In some embodiments, the shoe 44 freely pivots about an axis to allow the user to adjust an angle at which the blade 26 engages the workpiece during a cut. In some embodiments, the reciprocating tool 10 may not include a shoe.

In other embodiments, the power tool 10 may include various handle embodiments, drive mechanisms, blade clamp mechanisms, and power configurations. In further embodiments, the power tool 10 may include other types of power and speed control switches or may not include a speed control feature.

FIGS. 3-5 illustrate an accessory 46 according to one embodiment of the invention. In the illustrated embodiment, the accessory 46 is a base or adapter for receiving various accessory blocks 90 that perform various functions. A user may attach one of several interchangeable accessory blocks 90 having different accessory elements 94 coupled thereto, such as a sponge, sanding accessory block, or wire brush to the accessory base 46. In the illustrated embodiment, the accessory element 94 is illustrated as a brush. In other embodiments, other accessory blocks 90 having other accessory elements 94 such as a plastic brush, a ¼ sheet sanding accessory block, a steel wool pad, a plastic scraper, a caulk removal tool, detail sanding shapes, detail scrapers, a plastic scrubbing pad, a rubber brush, a drywall rasp, a group removal tool, and a staple puller, etc. may be employed.

The accessory base 46 includes an attachment portion 48 and a body 50 extending from the attachment portion 48. The attachment portion 48 is substantially parallel with, and more specifically coincides with, an axis of reciprocation R of the reciprocating tool 10 when the accessory base 46 is attached to the blade clamp mechanism 12. The reciprocation axis R is substantially parallel to the longitudinal axis L of the tool 10.

The attachment portion 48 includes a tang 52 with an aperture 54. The tang 52 and the aperture 54 are configured to engage with the blade clamp mechanism 12 to securely and releasably couple the accessory base 46 to the reciprocating tool 10. In other embodiments, another configuration of attachment portion 48 may be employed to suit the blade clamp mechanism 12 of the reciprocating tool 10.

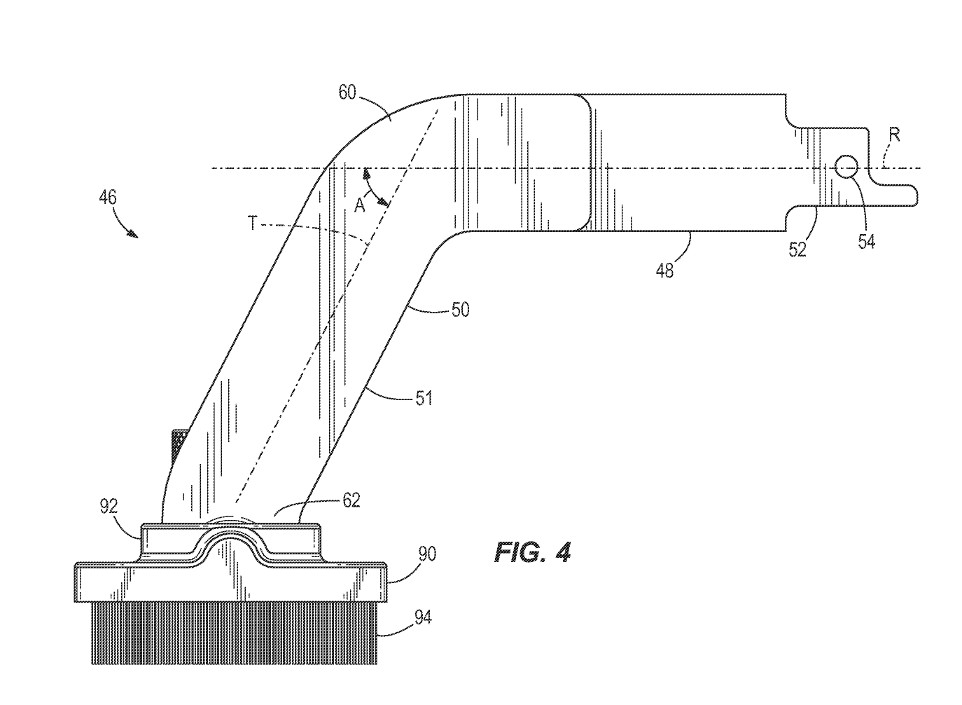

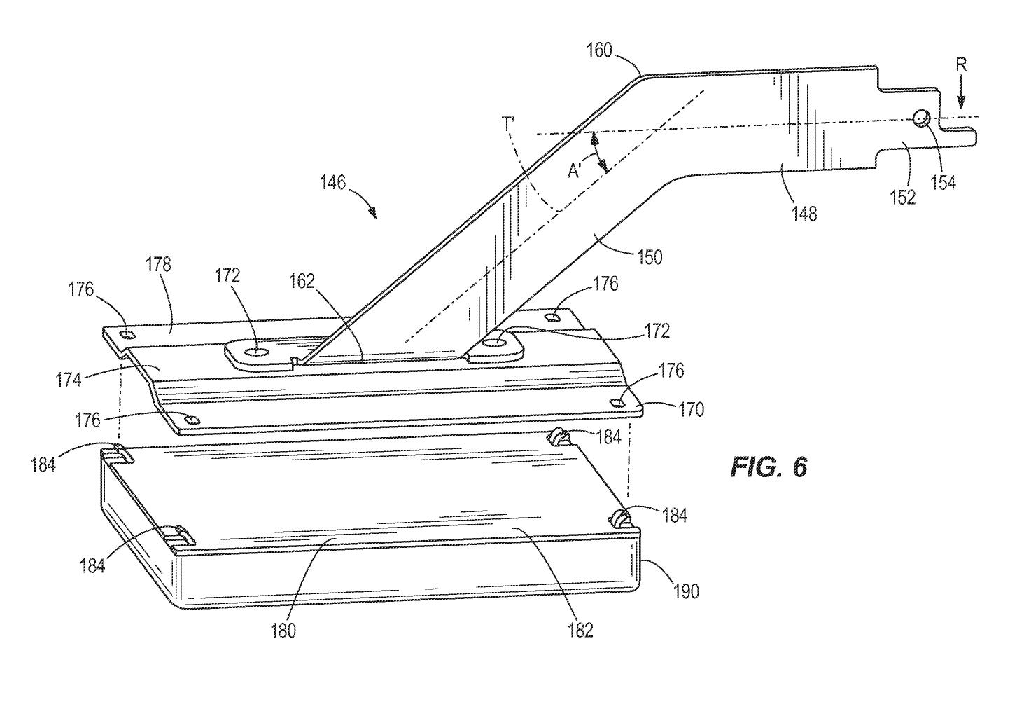

The body 50 of the accessory base 46 is angled downwards from the attachment portion 48 and the reciprocation axis R along an axis T, as shown in FIG. 4. The body 50 is angled with respect to the attachment portion 148 at an angle A, which is between about 30 degrees and about 60 degrees, and preferably about 60 degrees as in the illustrated embodiment. In other embodiments, the angle A is about 45 degrees, as illustrated in FIG. 6. In yet other embodiments, the angle A is less than 30 degrees or more than 60 degrees.

With reference to FIGS. 3-4, the body 50 extends from the attachment portion 48 and includes a first end 60 coupled to the attachment portion 48 and a second end 62 opposite the first end 60. The first end 60 has a generally horizontal orientation substantially parallel to the axis R. The second end 62 of the body 50 is coupled to or includes a mating member 70. In other embodiments, the mating member 70 may be disposed between the first end 60 and the second end 62 or elsewhere on the body 50. In the illustrated embodiment, the mating member 70 has a substantially rectangular base and a semi-cylindrical shape projecting from the substantially rectangular base and formed by stamping of the substantially rectangular base. However, other shapes or configurations of the mating member 70 are possible, and other manufacturing methods may be employed to form the desired shapes and configurations. The body 50 is formed with two arm portions 51, 52 that join together near the first end 60 where they extend from the attachment portion 48. The arm portions 51, 52 attach to opposing sides of the mating member 70 at the second end 62, the arm portions 51, 52 opposed laterally in a direction transverse to the axis R on opposite sides of the axis R. The mating member 70 provides a surface for engaging with and mating with the accessory block 90, as will be described in greater detail below.

As illustrated in FIGS. 3-5, the attachment portion 48, body 50, and mating member 70 are integrally formed by stamping as a single piece that wraps around and is fastened to itself, e.g., by rivets or other suitable fasteners or joining processes. In other embodiments, the attachment portion 48, body 50, and mating member 70 may be formed from multiple pieces (e.g., three pieces) fastened together by any suitable means such as spot welding or rivets.

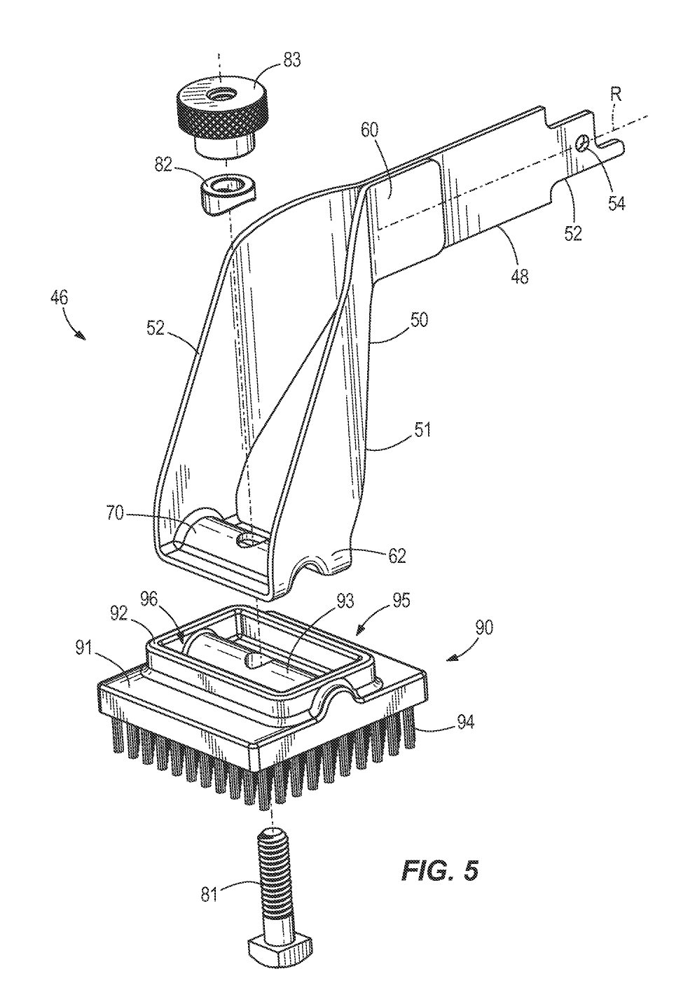

As shown in FIG. 5, the accessory block 90 includes a planar upper surface 91. The upper surface 91 includes an accessory mating portion 95 having an extruded border portion 92 projecting away from the upper surface 91 and defining a receptacle 96 for receiving the second end 62 (e.g., the substantially rectangular base of the mating member 70) and generally locating the second end 62 with respect to the accessory block 90. The extruded border portion 92 and receptacle 96 are shaped and sized to receive the mating member 70. In the illustrated embodiment, the extruded border portion 92 and receptacle 96 are substantially rectangular for receiving the substantially rectangular base of the mating member 70. In other embodiments, other suitable shapes and sizes may be employed.

The accessory block 90 also includes an extruded inner portion or locating member 93 projecting away from the upper surface 91 and positioned within the extruded border portion 92 and within the receptacle 96. The accessory mating portion 95 is configured to mate with or be complementary to the second end 62 (e.g., the mating member 70) of the body 50. Specifically, the extruded border portion 92 receives the mating member 70 and the locating member 93 nests or mates with the mating member 70. A fastener 80 secures the body 50 (via the mating member 70) to the accessory block 90. In the illustrated embodiment, the locating member 93 is a semi-cylindrical shape. In other embodiments, the locating member 93 and the mating member 70 may have other complementary or mating shapes.

As shown in FIG. 5, the fastener 80 includes a bolt 81, a washer 82, and a threaded cap 83. The bolt 81 is inserted through matching holes formed in the accessory block 90 (via the portion 93) and the upper plate 70, and is secured in place by the washer 82 and threaded cap 83. In other embodiments, the fastener 80 for coupling the body 50 to the accessory block 90 may include an adhesive, a magnet, a detent mechanism, a latch, and other fasteners, etc.

As discussed above, the accessory block 90 may include one or more accessory elements 94. In the illustrated embodiment, the accessory element 94 includes a brush, such as a wire brush or a plastic brush. In other embodiments, other types of accessory elements may be employed. In some embodiments, the accessory block 90 is consumable and replaceable. In other embodiments, the accessory elements 94 may be removably coupled to the accessory block 90 such that the accessory block 90 can be reused and new accessory elements 94 may be coupled to the accessory block 90. The accessory block 90 is oriented substantially in a plane that is generally parallel to the reciprocation axis R and a working surface such that a lower surface of the accessory block 90 (e.g., including the accessory element 94) may be reciprocated along the surface. The working surface may be a floor, a workpiece, a wall, or any other surface requiring treatment with one of the accessory elements 94 included on the accessory block 90 of the accessory base 46.

FIG. 6 illustrates an accessory 146 according to another embodiment of the invention. The accessory 146 functions similarly to the accessory 46 described above, but has a different construction. In the illustrated embodiment, the accessory 146 is an accessory base that performs various functions. A user may attach one of several interchangeable accessory blocks 190, such as a sponge, sanding accessory block, or a wire brush to the accessory base 146. The accessory base 146 includes an attachment portion 148 and a body 150 extending from the attachment portion 148. The attachment portion 148 is substantially parallel with the reciprocation axis R of the reciprocating tool 10 when the accessory base 146 is attached to the blade clamp mechanism 12. The reciprocation axis R is substantially parallel to the longitudinal axis L and, more specifically, coincides with the longitudinal axis L.

The attachment portion 148 includes a tang 152 with an aperture 154. The tang 152 and the aperture 154 are configured to engage with the blade clamp mechanism 12 to securely and releasably couple the accessory base 146 to the reciprocating tool 10. In other embodiments, other types or configurations of attachment portions may be employed in order to suit the blade clamp mechanism 12 of the reciprocating tool 10.

The body 150 of the accessory base 146 has a generally trapezoidal shape and is angled downwards from the attachment portion 148 and the reciprocation axis R along an axis T′, as shown in FIG. 6. The body 150 is angled with respect to the attachment portion 148 at an angle A′, which is between 30 degrees and about 60 degrees, and preferably about 45 degrees in the illustrated embodiment. The body 150 includes a first end 160 coupled to the attachment portion 148 and a second end 162 opposite the first end 160, which has a generally horizontal orientation substantially parallel to the axis R.

With continued reference to FIG. 6, the second end 162 of the body 150 is coupled to an upper plate 170 via a securing member, such as a screw, inserted through apertures 172. In other embodiments, the second end 162 may be coupled to the upper plate 170 by other means, such as rivets, an adhesive, or may be integrally formed with the upper plate 170 as a single piece. In the illustrated embodiment, the upper plate 170 includes a raised middle portion 174 along its length, and the second end 162 is coupled to the upper plate 170 along the raised middle portion 174. The upper plate 170 also includes an aperture 176 proximate each of four corners of an upper surface 178 of the upper plate 170 to facilitate attachment to a lower plate 180.

The lower plate 180 has a planar upper surface 182, which is configured to lie against a lower surface of the upper plate 170. In the illustrated embodiment of FIG. 6, the lower plate 180 includes a tab 184 projecting towards the upper plate 170 of the body 150 and located proximate each of four corners of the upper surface 182 of the lower plate 180 to facilitate attachment to the upper plate 170. When assembled, the tabs 184 are aligned with the apertures 176 in the upper plate 170 so that the tabs 184 may be inserted through the holes 176 to couple the upper plate 170 with the lower plate 180. Thus, the holes 176 are a mating portion for receiving the tabs 184 within the holes 176 for mating and securing the accessory block 190 to the body 150. In other embodiments, the upper plate 170 may be mechanically joined to the lower plate 180 via other connections, such as with screws, adhesives, or magnets.

The accessory block 190 is coupled to a lower surface of the lower plate 180. The accessory block 190 may be one of several interchangeable accessory blocks having various accessory elements, such as a sponge, sanding block, or a wire brush. In other embodiments, other accessory blocks 190 having other accessory elements such as a plastic brush, a ¼ sheet sanding accessory block, a steel wool pad, a plastic scraper, a caulk removal tool, detail sanding shapes, detail scrapers, a plastic scrubbing pad, a rubber brush, a drywall rasp, a group removal tool, and a staple puller, etc. may be employed. In further embodiments, other types of accessory blocks and accessory elements may be used. The accessory block 190 is oriented substantially in a plane that is generally parallel to the reciprocation axis R and a working surface such that a lower surface of the accessory block 190 may be reciprocated along the surface. The surface may be a floor, a workpiece, a wall, or any other surface needing treatment with one of the accessories of the accessory base 146.

During operation of the accessory base 46, 146, the lower surface of the accessory block 90, 190 reciprocates along the surface to perform a desired operation, such as sanding, cleaning, or dusting.

Thus, the invention provides, among other things, a reciprocating saw having an accessory base for performing various treatments to a surface. Although the invention has been described in detail with reference to certain preferred embodiments, variations and modifications exist within the scope and spirit of one or more independent aspects of the invention as described. Various features and advantages of the invention are set forth in the following claims.

What is claimed is:

1. An accessory for a reciprocating power tool, the accessory comprising:
an attachment portion configured to be coupled to the reciprocating power tool;
a body portion extending from the attachment portion, the body portion including a mating member;
an accessory block having an accessory mating portion configured to mate with the mating member of the body portion, wherein the accessory mating portion includes a locating member that projects towards the mating member, the locating member being received within the mating member for mating with the mating member; and
an accessory element coupled to the accessory block, the accessory element for engaging a workpiece.

2. The accessory of claim 1, wherein the accessory block further comprises a receptacle configured to receive the mating member, wherein the locating member is disposed in the receptacle.

3. The accessory of claim 2, wherein the receptacle is defined by an extruded border portion that projects away from an upper surface of the accessory block.

4. The accessory of claim 3, wherein the extruded border portion is substantially rectangular.

5. The accessory of claim 4, wherein the locating member and the mating member include substantially semi-cylindrical portions configured to correspond in shape and size.

6. The accessory of claim 2, wherein the receptacle is substantially rectangular.

7. The accessory of claim 1, wherein the mating member and the locating member include substantially semi-cylindical portions.

8. The accessory of claim 7, wherein the mating member is concave with respect to the accessory block and wherein the locating member is convex with respect to the mating member such that the mating member receives the locating member.

9. The accessory of claim 1, wherein the locating member includes at least one tab and wherein the mating member includes at least one hole, wherein the at least one tab is received in the at least one hole for securing the accessory block to the body portion.

10. The accessory of claim 9, wherein the at least one tab includes at least four tabs disposed proximate respective corners of the accessory block, and wherein the at least one hole includes at least four holes disposed proximate respective corners of the mating member.

11. The accessory of claim 1, wherein the accessory element includes a brush.

12. The accessory of claim 1, wherein a fastener clamps the accessory block to the body portion.

13. The accessory of claim 12, wherein the accessory block and the body portion include an aperture through which the fastener passes.

14. The accessory of claim 13, wherein the aperture passes through the locating member and the mating member.

15. The accessory of claim 14, wherein the fastener is received by a threaded cap for clamping the accessory block to the mating member.

16. The accessory of claim 1, wherein the body includes a first arm portion and a second arm portion, the first and second arm portions coupled on opposite sides to the mating member.

17. The accessory of claim 16, wherein the attachment portion generally defines a reciprocation axis and wherein the first arm portion and second arm portion are disposed laterally on opposite sides of the reciprocation axis.

18. The accessory of claim 1, wherein the mating member includes a substantially rectangular base and a substantially semi-cylindrical shape projecting from the substantially rectangular base.

19. An accessory block for a reciprocating power tool having an adapter, the accessory block comprising:
an accessory element configured to engage a workpiece to perform an operation on the workpiece; and
an accessory mating portion configured to mate with the adapter, wherein the accessory mating portion includes:
a receptacle configured to receive the adapter; and
a locating member having a shape that corresponds with a shape of the adapter for mating with the adapter;
wherein the locating member is disposed in the receptacle.

20. The accessory of claim 19, wherein the receptacle is defined by an extruded border portion that projects away from an upper surface of the accessory block.

21. The accessory of claim 20, wherein the locating member projects away from the upper surface of the accessory block and is disposed within the extruded border portion.

22. The accessory of claim 21, wherein the extruded border portion is substantially rectangular.

23. The accessory of claim 22, wherein the locating member is substantially semi-cylindrical.

24. The accessory of claim 19, wherein the receptacle is substantially rectangular.

25. The accessory of claim 19, wherein the locating member is substantially semi-cylindical.

26. The accessory of claim 25, wherein the locating member is convex.

27. The accessory of claim 19, wherein the locating member projects away from an upper surface of the accessory block.

28. The accessory of claim 19, wherein the accessory element includes a brush.

29. The accessory of claim 19, wherein the accessory element includes a sanding pad.

30. The accessory of claim 19, wherein the accessory element includes a sponge.

31. The accessory of claim 19, wherein the accessory element includes a scraper.

32. The accessory of claim 19, wherein the accessory element includes a steel wool pad.

33. The accessory of claim 19, wherein the accessory block includes an aperture for receiving a fastener.

34. The accessory of claim 33, wherein the aperture passes through the locating member.

35. A reciprocating power tool, the reciprocating power tool comprising:
a motor having a drive shaft;
a blade clamp mechanism;
a drive mechanism coupled to the motor for converting rotational motion of the drive shaft into reciprocating motion of the blade clamp mechanism;
an accessory having an attachment portion configured to be coupled to the blade clamp mechanism and a body portion extending from the attachment portion and including a mating member;
an accessory block having an accessory mating portion configured to mate with the mating member, wherein the accessory mating portion includes a receptacle configured to receive the mating member and a locating member having a shape that corresponds with the mating member for mating with the mating member, and further wherein the locating member is disposed in the receptacle; and
an accessory element coupled to the accessory block, the accessory element for engaging a workpiece.

36. The accessory of claim 35, wherein the accessory block further comprises a receptacle configured to receive the mating member, wherein the locating member is disposed in the receptacle

37. The accessory of claim 36, wherein the receptacle is defined by an extruded border portion that projects away from an upper surface of the accessory block.

38. The accessory of claim 37, wherein the extruded border portion is substantially rectangular.

39. The accessory of claim 38, wherein the locating member and the mating member include substantially semi-cylindrical portions configured to correspond in shape and size.

40. The accessory of claim 36, wherein the receptacle is substantially rectangular.

41. The accessory of claim 35, wherein the mating member and the locating member include substantially semi-cylindical portions.

42. The accessory of claim 41, wherein the mating member is concave with respect to the accessory block and wherein the locating member is convex with respect to the mating member such that the mating member receives the locating member.

43. The accessory of claim 35, wherein the locating member includes at least one tab and wherein the mating member includes at least one hole, wherein the at least one tab is received in the at least one hole for securing the accessory block to the body portion.

44. The accessory of claim 43, wherein the at least one tab includes at least four tabs disposed proximate respective corners of the accessory block, and wherein the at least one hole includes at least four holes disposed proximate respective corners of the mating member.

45. The accessory of claim 35, wherein the accessory element includes a brush.

46. The accessory of claim 35, wherein a fastener clamps the accessory block to the body portion.

47. The accessory of claim 46, wherein the accessory block and the body portion include an aperture through which the fastener passes.

48. The accessory of claim 47, wherein the aperture passes through the locating member and the mating member.

49. The accessory of claim 48, wherein the fastener is received by a threaded cap for clamping the accessory block to the mating member.

50. The accessory of claim 35, wherein the body includes a first arm portion and a second arm portion, the first and second arm portions coupled on opposite sides to the mating member.

51. The accessory of claim 50, wherein the attachment portion generally defines a reciprocation axis and wherein the first arm portion and second arm portion are disposed laterally on opposite sides of the reciprocation axis.

52. The accessory of claim 35, wherein the mating member includes a substantially rectangular base and a substantially semi-cylindrical shape projecting from the substantially rectangular base.
